(19) United States
(12) Patent Application Publication
(10) Pub. No.: US 2025/0232749 A1
(43) Pub. Date: Jul. 17, 2025

(54) VARIABLE PICKUP TECHNOLOGY FOR GUITARS

(71) Applicant: Bayou Guitars LLC, Salt Lake City, UT (US)

(72) Inventors: Lance Wright, Humble, TX (US); Mike Sherry, Mandeville, LA (US)

(21) Appl. No.: 18/413,321

(22) Filed: Jan. 16, 2024

(51) Int. Cl. G10H 3/18; G10D 1/08; G10H 1/14; G10H 1/18; G10H 1/46

(52) U.S. Cl. CPC G10H 3/182; G10D 1/085; G10H 1/14; G10H 1/18; G10H 1/46; G10H 3/181; G10H 2220/515

(57) ABSTRACT

Variable pickup technology can be implemented on guitars. A guitar having variable pickup technology includes a variable ground path at a center tap of a humbucker pickup. The guitarist can vary this ground path across a continuous range of resistances. As a result, a single humbucker pickup can enable an infinite blend of sounds between a single coil configuration and a humbucker configuration. A guitar can include multiple humbucker pickups having variable pickup technology.

### CROSS-REFERENCE TO RELATED APPLICATIONS

N/A

### BACKGROUND

A pickup is a component of a guitar that captures mechanical vibrations produced by the strings and converts the vibrations into electrical signals which can then be amplified and output through a speaker. Guitars employ two main types of pickups. A single coil pickup includes a single wire coil that is positioned around a series of magnets that are positioned adjacent to the strings of the guitar. As the strings vibrate, the magnetic field created by the magnets is disturbed. This changing magnetic field induces a current in the single coil thereby creating the electrical signal that can be amplified and output.

A single coil pickup is susceptible to interference from nearby electric components which is manifested as a hum in the audible output. Therefore, humbucker pickups have been developed. A humbucker pickup includes two wire coils that are each positioned around a respective series of magnets. The wire coils are wrapped in opposite directions and connected in series. The polarity of the respective series of magnets is also reversed. As a result, the interference picked up by each coil assembly will be 180 degrees out of phase and will therefore cancel thereby leaving a “cleaner” electrical signal.

### BRIEF SUMMARY

The present disclosure relates to variable pickup technology of guitars. In particular, a guitar having variable pickup technology includes a variable ground path at a center tap of a humbucker pickup. The guitarist can vary this ground path across a continuous range of resistances. As a result, a single humbucker pickup can enable an infinite blend of sounds between a single coil configuration and a humbucker configuration. A guitar can include multiple humbucker pickups having variable pickup technology.

In some embodiments, the present disclosure may be implemented as a circuit of a guitar for providing variable pickup technology. The circuit may include a first humbucker pickup having a first coil and a second coil. The circuit may also include a first variable pickup control comprising a first variable resistor to which ends of the first and second coils of the first humbucker pickup are connected. A first electrical signal generated by the first humbucker pickup may be altered by the first variable pickup control based on a value of the first variable resistor. The circuit may further include a second humbucker pickup having a first coil and a second coil. The circuit may additionally include a second variable pickup control comprising a second variable resistor to which ends of the first and second coils of the second humbucker pickup are connected. A second electrical signal generated by the second humbucker pickup may be altered by the second variable pickup control based on a value of the second variable resistor.

In some embodiments, the first variable resistor may connect the ends of the first and second coils of the first humbucker pickup to ground.

In some embodiments, the second variable resistor may connect the ends of the first and second coils of the second humbucker pickup to ground.

In some embodiments, a start of the first coil of the first humbucker pickup and a start of the second coil of the second humbucker pickup may be connected to ground.

In some embodiments, the circuit may also include a pickup selector. A start of the second coil of the first humbucker pickup and a start of the first coil of the second humbucker pickup may be connected to inputs of the pickup selector.

In some embodiments, the circuit may also include a volume control. An output of the pickup selector may be connected to an input of the volume control.

In some embodiments, the circuit may also include a tone control. The output of the pickup selector may be connected to an input of the tone control.

In some embodiments, the circuit may also include a first volume control forming a first voltage divider for the first electrical signal output at a start of the second coil of the first humbucker pickup and a second volume control forming a second voltage divider for the second electrical signal output at a start of the first coil of the second humbucker pickup.

In some embodiments, the circuit may also include a pickup selector for selecting either or both the first or second electrical signals.

In some embodiments, the circuit may also include a tone control connected to an output of the pickup selector.

In some embodiments, the first coil of the first humbucker pickup may be a south coil and the first coil of the second humbucker pickup may be a south coil.

In some embodiments, the circuit may also include a third humbucker pickup having a first coil and a second coil and a third variable pickup control comprising a third variable resistor to which ends of the first and second coils of the third humbucker pickup are connected. A third electrical signal generated by the third humbucker pickup may be altered by the third variable pickup control based on a value of the third variable resistor.

In some embodiments, the first variable resistor and the second variable resistor may each be a 100k ohm rheostat.

In some embodiments, the present disclosure may be implemented as a guitar having a main body, a neck, strings, a first humbucker pickup having a first coil and a second coil, a first volume control, a first tone control, a jack and a first variable pickup control comprising a first variable resistor to which ends of the first and second coils of the first humbucker pickup are connected. A first electrical signal generated by the first humbucker pickup and output at the jack may be altered by the first variable pickup control based on a value of the first variable resistor.

In some embodiments, the guitar may also include a second humbucker pickup having a first coil and a second coil and a second variable pickup control comprising a second variable resistor to which ends of the first and second coils of the second humbucker pickup are connected. A second electrical signal generated by the second humbucker pickup and output at the jack may be altered by the second variable pickup control based on a value of the second variable resistor.

In some embodiments, the first volume control and the first tone control may be configured to alter the first electrical signal and the second electrical signal.

In some embodiments, the first volume control may configured to alter the first electrical signal and the guitar may also include a second volume control that is configured to alter the second electrical signal.

In some embodiments, the first tone control may be configured to alter the first electrical signal and the guitar may also include a second tone control that is configured to alter the second electrical signal.

In some embodiments, the present disclosure may be implemented as a circuit of a guitar for providing variable pickup technology. The circuit may include a first humbucker pickup having a first coil and a second coil. The first coil may have a start and an end and the second coil may have a start and an end. The circuit may also include a first variable pickup control comprising a first variable resistor to which the ends of the first and second coils of the first humbucker pickup may be connected. The start of the first coil may be connected to ground. The start of the second coil may be connected to an output of the guitar and a first electrical signal at the start of the second coil may be altered by the first variable pickup control based on a value of the first variable resistor.

In some embodiments, the circuit may also include a volume control and a tone control to which the first electrical signal may be subject.

This summary is provided to introduce a selection of concepts in a simplified form that are further described below in the Detailed Description. This summary is not intended to identify key features or essential features of the claimed subject matter.

### BRIEF DESCRIPTION OF THE DRAWINGS

Understanding that these drawings depict only typical embodiments of the present disclosure and are not therefore to be considered limiting of its scope, the present disclosure will be described and explained with additional specificity and detail through the use of the accompanying drawings in which:

FIG. 1 is an example of a guitar that includes variable pickup technology in accordance with one or more embodiments of the present disclosure;

FIG. 2 is a schematic of an example of how variable pickup technology can be implemented in one or more embodiments of the present disclosure;

FIG. 3 is a schematic of another example of how variable pickup technology can be implemented in one or more embodiments of the present disclosure; and

FIG. 4 is a schematic of another example of how variable pickup technology can be implemented in one or more embodiments of the present disclosure.

### DETAILED DESCRIPTION

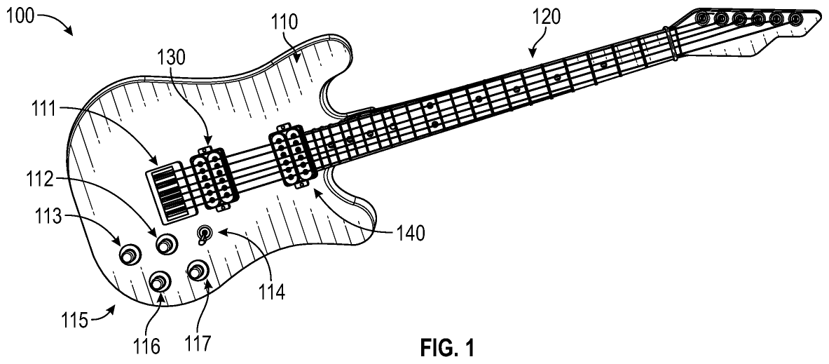

FIG. 1 shows a guitar 100 that includes variable pickup technology in accordance with one or more embodiments of the present disclosure. Guitar 100 includes a body 110 and a neck 120. The strings extend along the neck to a bridge 111 on the body 110. A first humbucker pickup 130 is positioned towards bridge 111. A second humbucker pickup 140 is positioned towards neck 120. Guitar 100 can also include a volume control 112 (for controlling the amplitude of the electrical signal generated by guitar 100), a tone control 113 (for controlling the tone of the electrical signal generated by guitar 100), a pickup selector 114 (for activating either or both first humbucker pickup 130 or second humbucker pickup 140), a jack 115 (by which the electrical signal is output from guitar 100), a first variable pickup control 116 and a second variable pickup control 117, all of which may typically be positioned on body 110. As described in detail below, first variable pickup control 116 allows the guitarist to control the variable pickup technology of first humbucker pickup 130 and second variable pickup control 117 allows the guitarist to control the variable pickup technology of second humbucker pickup 140.

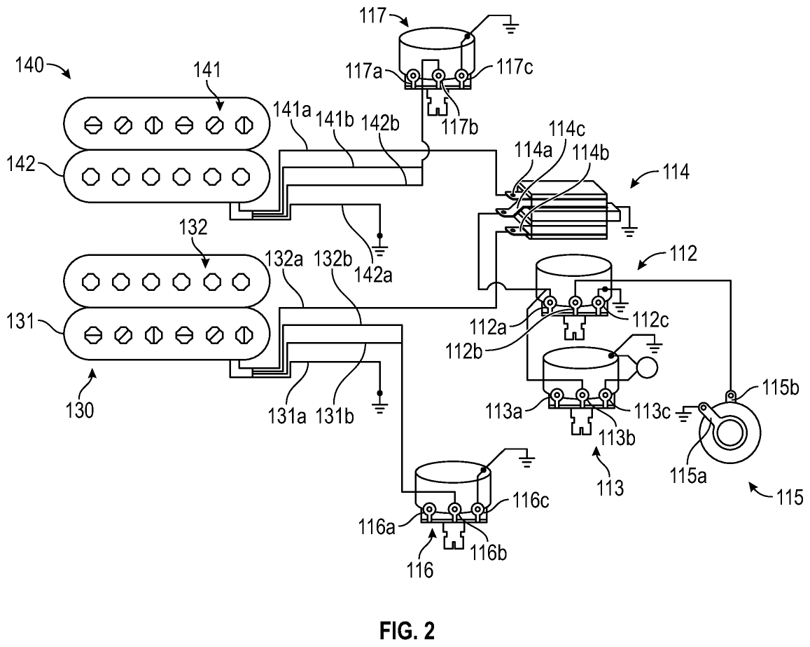

FIG. 2 is a schematic of an example circuit that may be used to implement variable pickup technology on guitar 100 of FIG. 1. This circuit includes first humbucker pickup 130 and second humbucker pickup 140. The depicted orientation and configuration of the coil assemblies in first and second humbucker pickups 130 and 140 is merely one example and any suitable orientation or configuration could be used.

First humbucker pickup 130 includes a first coil 131 (e.g., a south coil) and a second coil 132 (e.g., a north coil), each of which is wrapped around a series of six magnets. First coil 131 includes a start 131a and an end 131b, and second coil 132 includes a start 132a and an end 132b.

Similarly, second humbucker pickup 140 includes a first coil 141 (e.g., a south coil) and a second coil 142 (e.g., a north coil), each of which is wrapped around a series of six magnets. First coil 141 includes a start 141a and an end 141b, and second coil 142 includes a start 142a and an end 142b.

Volume control 112 can be implemented as a variable resistance element (e.g., a potentiometer) having a first terminal 112a, a second terminal 112b, and a third terminal 113c. First terminal 112a and third terminal 112c are connected to opposing ends of a resistive element that creates a fixed resistance between these terminals, and second terminal 112b (e.g., the wiper terminal) is connected to the resistive element in a manner that will cause it to experience a variable resistance relative to first terminal 112a and third terminal 112c based on a position of an input element (e.g., a knob) of volume control 112.

Tone control 113 may be implemented in a similar manner as volume control 112 and may therefore have a first terminal 113a, a second terminal 113b, and a third terminal 113c.

Pickup selector 114 may be implemented as a switch (e.g., a toggle switch, a lever switch, or other switch) that allows the outputs of one or both of first humbucker pickup 130 and second humbucker pickup 140 to be connected to jack 115. For example, pickup selector 114 could have a first input terminal 114a and a second input terminal 114b which can be selectively connected to an output terminal 114c based on a position of an input element (e.g., a lever).

Output terminal 114c can be connected to tip 115b of jack 115 via volume control 112 and tone control 113 such that the electrical signal output from first humbucker pickup 130 and/or second humbucker pickup 140 will be subjected to volume control 112 and tone control 113 before being output via jack 115. Sleeve 115a of jack 115 can be connected to ground. As one example, output terminal 114c could be connected to first terminal 112a of volume control 112, second terminal 112b of volume control 112 can be connected to tip 115b of jack 115 and third terminal 113c of volume control 112 can be connected to ground such that volume control 112 functions as a voltage divider on the electrical signal output from pickup selector 114. Additionally, output terminal 114c could be connected to second terminal 113b of tone control 113 and third terminal 113c of tone control 113 can be connected to ground via a capacitor to thereby implement a variable resistor-capacitor path for controlling the filtering of frequency components from the electrical signal to be output from jack 115.

To implement variable pickup technology for first humbucker pickup 130, start 131a of first coil 131 can be connected to ground, start 132a of second coil 132 can be connected to one of the inputs (e.g., second input terminal 114b) of pickup selector 114, and ends 131b and 132b of first coil 131 and second coil 132 respectively can both be connected to first variable pickup control 116. Similarly, to implement variable pickup technology for second humbucker pickup 140, start 141a of first coil 141 can be connected to the other of the inputs (e.g., first input terminal 114a) of pickup selector 114, start 142a of second coil 132 can be connected to ground, and ends 141b and 142b of first coil 141 and second coil 142 respectively can both be connected to second variable pickup control 117.

First variable pickup control 116 may be implemented using a component that provides variable resistance such as a rheostat or a potentiometer configured to function as a rheostat. For example, first variable pickup control 116 may include a first terminal 116a, a second terminal 116b, and a third terminal 116c. First terminal 116a and third terminal 116c are connected to opposing ends of a resistive element that creates a fixed resistance between these terminals, and second terminal 116b (e.g., the wiper terminal) is connected to the resistive element in a manner that will cause it to experience a variable resistance relative to first terminal 116a and third terminal 116c based on a position of an input element (e.g., a knob) of first variable pickup control 116. Ends 131b and 132b of first coil 131 and second coil 132 can both be connected to second terminal 116b and third terminal 116c can be connected to ground.

Second variable pickup control 117 may also be implemented using a component that provides variable resistance. For example, second variable pickup control 117 may include a first terminal 117a, a second terminal 117b, and a third terminal 117c. First terminal 117a and third terminal 117c are connected to opposing ends of a resistive element that creates a fixed resistance between these terminals, and second terminal 117b (e.g., the wiper terminal) is connected to the resistive element in a manner that will cause it to experience a variable resistance relative to first terminal 117a and third terminal 117c based on a position of an input element (e.g., a knob) of second variable pickup control 117. Ends 141b and 142b of first coil 141 and second coil 142 can both be connected to second terminal 117b and third terminal 117c can be connected to ground.

Accordingly, first variable pickup control 116 provides a variable resistance ground path from a center tap of first humbucker pickup 130 and second variable pickup control 117 provides a variable resistance ground path from a center tap of second humbucker pickup 140. In particular, the guitarist can vary the resistance of first variable pickup control 116 and second variable pickup control 117 across a continuous range of resistances which in turn can cause a varied response at the electrical signal present on start 132a and start 141a respectively. This varied response at the respective electrical signal can cause the electrical signal to exhibit an essentially infinite blend of sounds.

First variable pickup control 116 and second variable pickup control 117 can be configured to present a resistance that varies between a minimum value and a maximum value. In some embodiments, the minimum value may be zero ohms (or approximately zero ohms). In such embodiments, when first variable pickup control 116 or second variable pickup control 117 is set to the minimum value, first coil 131 or second coil 142 respectively will be deactivated (thus creating a single coil configuration) due to both start 131a and end 131b or start 142a and end 142b respectively being connected to ground. In other embodiments, the minimum value may be greater than zero ohms such that the influence of first coil 131 or second coil 142 may be minimized rather than being deactivated.

In some embodiments, the maximum value may be sufficient to effectively eliminate current flow through first variable pickup control 116 or second variable pickup control 117 which in turn can maximize the influence of first coil 131 or second coil 142 respectively. In other words, when first variable pickup control 116 and/or second variable pickup control 117 is set to its maximum resistance, an effective series connection may be formed between ends 131a and 131b and/or ends 141b or 142b respectively (thus creating a humbucker configuration). The variable pickup control can be set to any resistance in the range between the minimum and maximum resistances thereby allowing the guitarist to create an infinite blend of sounds/tonalities between those created in the single coil configuration and humbucker configuration.

In some embodiments, a variable pickup control may be configured to provide a variable resistance between 0 and 500k ohms, between 0 and 250k ohms, between 0 and 200k ohms, between 0 and 150k ohms, between 0 and 100k ohms, between 0 and 50k ohms, between 25k and 175k ohms, between 50k and 150k ohms, or between some other reasonable range.

In the circuit of FIG. 2, the electrical signal that is subject to first variable pickup control 116 and/or the electrical signal that is subject to second variable pickup control 117 will also be subjected to volume control 112 and tone control 113 before being output to jack 115. Accordingly, the variable pickup technology implemented by this circuitry gives the guitarist a high level of control over the output of guitar 100 including enabling the guitarist to infinitely blend the sound between what would be output by a single coil pickup and a humbucker pickup.

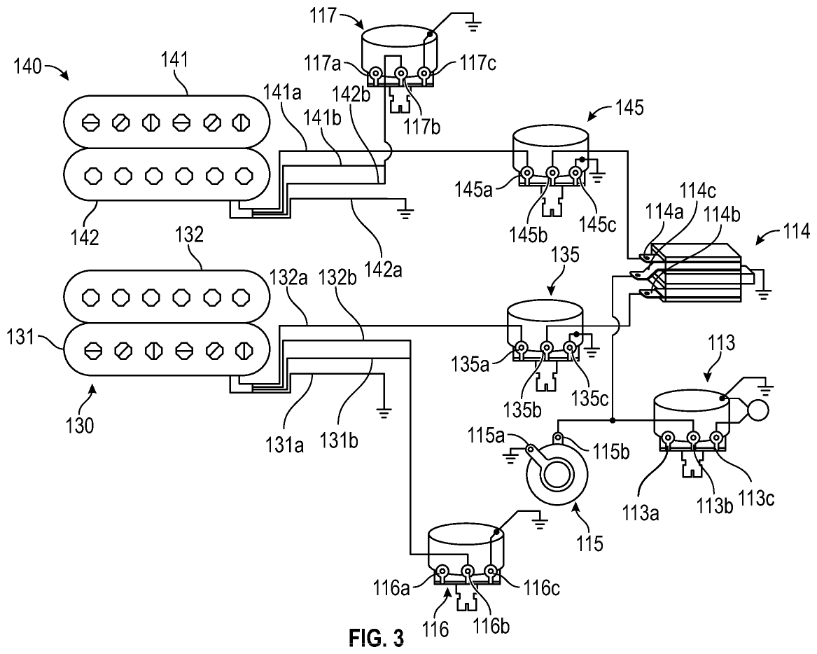

FIG. 3 is a schematic of another example circuit that may be used to implement variable pickup technology in accordance with one or more embodiments of the present disclosure. This circuit includes first humbucker pickup 130, second humbucker pickup 140, first variable pickup control 116, second variable pickup control 117, tone control 113, pickup selector 114, and jack 115 similar to the example circuit of FIG. 2 but also includes a first volume control 135 and a second volume control 145.

First volume control 135 includes a first terminal 135a, a second terminal 135b, and a third terminal 135c. Start 132a of second coil 132 is connected to first terminal 135a and second terminal 135b is connected to one of the inputs (e.g., second input terminal 114b) of pickup selector 114. Similarly, second volume control 145 includes a first terminal 145a, a second terminal 145b, and a third terminal 145c. Start 141a of first coil 141 is connected to first terminal 145a and second terminal 145b is connected to one of the inputs (e.g., first input terminal 114a) of pickup selector 114. Output terminal 114c of pickup selector 114 is connected to second terminal 113b of tone control 113 and to tip 115b of jack 115.

In the example circuit of FIG. 3, the guitarist can use first volume control 135 and second volume control 145 to vary the amplitude of the electrical signal incident at start 132a of second coil 132 and the electrical signal incident at start 141a of first coil 141 respectively. As such, first volume control 135 and second volume control 145 can each independently operate on the electrical signal subject to first variable pickup control 116 and second variable pickup control 117 respectively. On the other hand, tone control 113 can operate on a single selected electrical signal or the combined electrical signals based on the position of pickup selector 114.

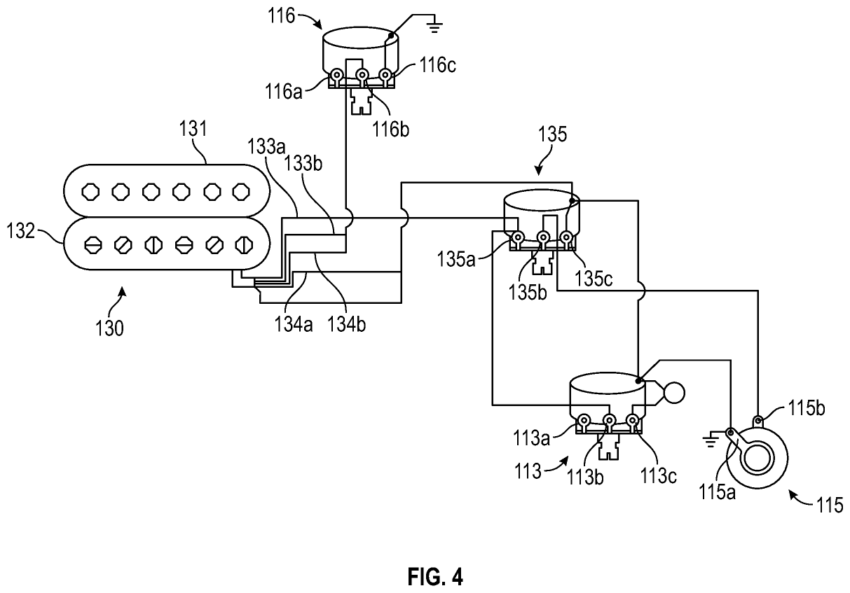

FIG. 4 is a schematic of another example circuit that may be used to implement variable pickup technology in accordance with one or more embodiments of the present disclosure. This circuit includes first humbucker pickup 130, first variable pickup control 116, tone control 113, and first volume control 135. FIG. 4 therefore represents an example of how variable pickup technology can be provided on a guitar having a single humbucker pickup.

Various other configurations of circuits could be used to provide variable pickup technology on a guitar having any reasonable number of humbucker pickups. For example, guitar 100 could include a third humbucker pickup and a third variable pickup control that are connected in a similar manner as shown in FIG. 2 along with a pickup selector that is capable of allowing any combination of the electrical signals from one or more of the three humbucker pickups to be output.

In some embodiments, the relative length of the coils in a humbucker pickup may be selected to vary the performance of a variable pickup control. For example, first variable pickup control 116 may be connected to end 131b of first coil 131 and end 132b of second coil 132 in a manner that causes the length of first coil 131 (or the length of the wire that forms first coil 131) to be longer than the length of second coil 132 (or the length of the wire that forms second coil 132), or vice versa. This varying of the relative lengths of the coils can cause the variable pickup control to impart different frequency responses to the output signal.

Any of the above-described features can be used on any embodiment that is configured in accordance with the present disclosure. In particular, no feature or combination of features should be limited to any of the embodiments depicted in the figures.

What is claimed:

1. A circuit of a guitar for providing variable pickup technology, the circuit comprising:
a first humbucker pickup having a first coil and a second coil;
a first variable pickup control comprising a first variable resistor to which ends of the first and second coils of the first humbucker pickup are connected, wherein a first electrical signal generated by the first humbucker pickup is altered by the first variable pickup control based on a value of the first variable resistor;
a second humbucker pickup having a first coil and a second coil; and
a second variable pickup control comprising a second variable resistor to which ends of the first and second coils of the second humbucker pickup are connected, wherein a second electrical signal generated by the second humbucker pickup is altered by the second variable pickup control based on a value of the second variable resistor.

2. The circuit of claim 1, wherein the first variable resistor connects the ends of the first and second coils of the first humbucker pickup to ground.

3. The circuit of claim 2, wherein the second variable resistor connects the ends of the first and second coils of the second humbucker pickup to ground.

4. The circuit of claim 3, wherein a start of the first coil of the first humbucker pickup and a start of the second coil of the second humbucker pickup are connected to ground.

5. The circuit of claim 4, further comprising:
a pickup selector, wherein a start of the second coil of the first humbucker pickup and a start of the first coil of the second humbucker pickup are connected to inputs of the pickup selector.

6. The circuit of claim 5, further comprising:
a volume control, wherein an output of the pickup selector is connected to an input of the volume control.

7. The circuit of claim 6, further comprising:
a tone control, wherein the output of the pickup selector is connected to an input of the tone control.

8. The circuit of claim 4, further comprising:
a first volume control forming a first voltage divider for the first electrical signal output at a start of the second coil of the first humbucker pickup; and
a second volume control forming a second voltage divider for the second electrical signal output at a start of the first coil of the second humbucker pickup.

9. The circuit of claim 8, further comprising:
a pickup selector for selecting either or both the first or second electrical signals.

10. The circuit of claim 9, further comprising:
a tone control connected to an output of the pickup selector.

11. The circuit of claim 1, wherein the first coil of the first humbucker pickup is a south coil and the first coil of the second humbucker pickup is a south coil.

12. The circuit of claim 1, further comprising:
a third humbucker pickup having a first coil and a second coil; and
a third variable pickup control comprising a third variable resistor to which ends of the first and second coils of the third humbucker pickup are connected, wherein a third electrical signal generated by the third humbucker pickup is altered by the third variable pickup control based on a value of the third variable resistor.

13. The circuit of claim 1, wherein the first variable resistor and the second variable resistor are each a 100k ohm rheostat.

14. A guitar comprising:
a main body;
a neck;
strings;
a first humbucker pickup having a first coil and a second coil;
a first volume control;
a first tone control;
a jack; and
a first variable pickup control comprising a first variable resistor to which ends of the first and second coils of the first humbucker pickup are connected, wherein a first electrical signal generated by the first humbucker pickup and output at the jack is altered by the first variable pickup control based on a value of the first variable resistor.

15. The guitar of claim 14, further comprising:
a second humbucker pickup having a first coil and a second coil; and
a second variable pickup control comprising a second variable resistor to which ends of the first and second coils of the second humbucker pickup are connected, wherein a second electrical signal generated by the second humbucker pickup and output at the jack is altered by the second variable pickup control based on a value of the second variable resistor.

16. The guitar of claim 15, wherein the first volume control and the first tone control are configured to alter the first electrical signal and the second electrical signal.

17. The guitar of claim 15, wherein the first volume control is configured to alter the first electrical signal, the guitar further comprising:
a second volume control that is configured to alter the second electrical signal.

18. The guitar of claim 17, wherein the first tone control is configured to alter the first electrical signal, the guitar further comprising:
a second tone control that is configured to alter the second electrical signal.

19. A circuit of a guitar for providing variable pickup technology, the circuit comprising:
a first humbucker pickup having a first coil and a second coil, the first coil having a start and an end, the second coil having a start and an end; and
a first variable pickup control comprising a first variable resistor to which the ends of the first and second coils of the first humbucker pickup are connected;
wherein the start of the first coil is connected to ground;
wherein the start of the second coil is connected to an output of the guitar and a first electrical signal at the start of the second coil is altered by the first variable pickup control based on a value of the first variable resistor.

20. The circuit of claim 19, further comprising:
a volume control; and
a tone control;
wherein the first electrical signal is subject to the volume control and the tone control.
